(19) United States
(12) Patent Application Publication
(10) Pub. No.: US 2016/0267563 A1
(43) Pub. Date: Sep. 15, 2016

(54) Methods and Systems for Managing and Tracking Electronic Contract Obligations

(71) Applicant: Adobe Systems Incorporated, San Jose, CA (US)

(72) Inventor: Benjamin David Follis, London (GB)

(21) Appl. No.: 14/645,770

(22) Filed: Mar. 12, 2015

(51) Int. Cl. G06Q 30/06; G06F 17/30

(52) U.S. Cl. CPC G06Q 30/0609; G06F 17/30525; G06F 17/30684; G06F 17/30864

(57) ABSTRACT

Systems and methods disclosed herein for providing information about an obligation of an electronic contract. One embodiment involves receiving, at an electronic contract obligation server, an annotation associated with the electronic contract, the annotation specifying the obligation to be performed by a performing participant of the electronic contract according to a time constraint for the benefit of a benefited participant of the electronic contract, the electronic contract obligation server independent of the performing participant and the benefited participant. The embodiment further involves identifying, by the electronic contract obligation service, the information about the obligation based on the annotation associated with the electronic contract. The embodiment further involves providing, by the electronic contract obligation service, the information about the obligation to the performing participant or the benefited participant.

### TECHNICAL FIELD

This disclosure relates generally to computer-implemented methods and systems and more particularly relates to improving the efficiency and effectiveness of computing systems used in managing and tracking electronic contract obligations.

### BACKGROUND

Contracts frequently create obligations on the part of one or more of the participants to act or not act in the future. For example, a contract may require that one participant pay another participant $100 per month for each of the next 60 months. Such obligations can continue for short or long periods of time. Both the performing participant and the benefited participant are burdened with having to separately track the obligations that are to be performed by the performing participant for the benefit of the benefited participant. Moreover, electronic contracts are often archived in secure document management systems with restricted access, stored in inaccessible locations, or otherwise lost or rendered inaccessible over time. As a result, managing and tracking performance of obligations according to contract terms is often quite burdensome on the participants and subject to error.

Business entities generally employ computer systems to facilitate tracking of the obligations of the business. However, such systems track obligations separately from the contracts. Business personnel can access obligation information but often have no way of confirming the accuracy of the obligation information relative to the contract since the contract is often unknown, inaccessible, or impractical to access. Contract participants cannot easily understand the basis of their obligations since the electronic contracts are separate from the obligation information.

Additional issues arise when one electronic contract participant is responsible for reminding or otherwise notifying another electronic contract participant of an obligation. For example, a lawn service may send a corporation an invoice or monthly reminder to pay a monthly fee for lawn service according to a variable monthly fee schedule of an electronic contract. The corporation may spend time confirming that the monthly reminder accurately reflects the terms of the electronic contract or risks responding to an inaccurate reminder.

In sum, because electronic contracts are often archived in restricted, inaccessible, or impractical locations or lost, it is burdensome for contract participants to adequately manage and track obligations created by their electronic contracts.

### SUMMARY

Systems and methods disclosed herein provide information about an obligation of an electronic contract. One embodiment involves receiving, at an electronic contract obligation server, an annotation associated with the electronic contract, the annotation specifying the obligation to be performed by a performing participant of the electronic contract according to a time constraint for the benefit of a benefited participant of the electronic contract, the electronic contract obligation server independent of the performing participant and the benefited participant. The embodiment further involves identifying, by the electronic contract obligation service, the information about the obligation based on the annotation associated with the electronic contract. The embodiment further involves providing, by the electronic contract obligation service, the information about the obligation to the performing participant or the benefited participant.

Systems and methods disclosed herein also annotate an electronic contract to provide information about an obligation of the electronic contract. One embodiment involves identifying the obligation associated with a subsection of the electronic contract, where the obligation is to be performed by a performing participant of the electronic contract according to a time constraint for the benefit of a benefited participant of the electronic contract. The embodiment further involves creating an annotation specifying the obligation and the time constraint. The embodiment further involves associating the annotation with the electronic contract, wherein the annotation is used to identify information about the obligation that is provided to the performing participant or the benefited participant.

These illustrative embodiments and features are mentioned not to limit or define the disclosure, but to provide examples to aid understanding thereof. Additional embodiments are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings.

FIG. 1 is a block diagram depicting an example of a system for monitoring and tracking obligations of electronic contracts using an independent server.

FIG. 2 is a block diagram illustrating exemplary modules for implementing functions in the monitoring server of FIG. 1.

FIG. 3 is a flow chart of an exemplary method for providing information about an obligation of an electronic contract.

FIG. 4 is a flow chart of another exemplary method for providing information about an obligation of an electronic contract.

FIG. 5 is a flow chart of an exemplary method of using notification parameters to notify a participant regarding an electronic contract obligation.

FIG. 6 is a flow chart of an exemplary method of creating an annotation associated with an electronic contract to specify an obligation of the electronic contract.

FIG. 7 is a flow chart of an exemplary method for managing electronic signatures and obligation tracking for electronic contracts.

FIG. 8 is a block diagram depicting example hardware implementations for the components described in FIG. 1.

### DETAILED DESCRIPTION

Because electronic contracts are often archived in restricted, inaccessible, or impractical locations or lost, it is burdensome for contract participants to adequately manage and track obligations created by electronic contracts. One embodiment of this invention addresses these issues by providing an electronic contract obligation server that is independent of the electronic contract participants to manage and track obligations. This tracking is accomplished using a contract annotation that specifies an obligation to be performed by a performing participant of the electronic contract according to a time constraint for the benefit of a benefited participant of the electronic contract. The electronic contract obligation server uses the annotations to send notifications or otherwise provide information to one or more of the participants regarding the electronic contract obligation. For example, both the performing participant and the benefited participant may receive a reminder a week before a payment from the performing participant is due to the benefited participant. In another example, an electronic contract participant logs in to an account on the server to access a user interface that presents all of his obligations due to be performed in the current month. Providing centralized and independent management of obligations generally reduces the burden on electronic contract participants to manage and track obligations themselves.

In addition, each annotation records an association between an obligation and the electronic contract that created the obligation. Associating an annotation with a particular electronic contract that created the obligation allows the contract corresponding to a particular annotation to be easily identified and/or accessed. For example, a notification that a payment is due in one week may include a copy of the electronic agreement. The obligation annotation specifies an obligations of an electronic contract in a way that allows the contract to be referenced when the obligation is reviewed by the participants. Moreover, associating an annotation with one or more particular electronic contract subsections provides additional benefits. For example, an annotation identifying a subsection (e.g., particular clauses) of an electronic contract specifying payment terms allows the electronic contract obligation server to send a reminder regarding the upcoming payment with a link (or other direct reference) that provides direct access to the applicable electronic contract subsections. Where the contract or specific contract subsections are identified by an annotation, the electronic contract participants do not have to spend time and resources identifying, locating, and accessing the electronic contract and relevant subsections to confirm the accuracy of an obligation. The participants instead can easily identify the basis for the obligation.

These illustrative examples are given to introduce the reader to the general subject matter discussed here and are not intended to limit the scope of the disclosed concepts. The following sections describe various additional aspects and examples with reference to the drawings in which like numerals indicate like elements, and directional descriptions are used to describe the illustrative examples hut, like the illustrative examples, should not be used to limit the present disclosure.

As used herein, the phrase “electronic contract” refers to an electronically-stored or electronically-captured document or recording that represents or records a contract involving one or more participants. Electronic contracts may take the form of text, images, sounds, or videos stored in electronic document files, audio recordings, video recordings, or any other suitable electronic form.

As used herein, the phrase “obligation” refers an action, course of action, inaction, or limitation on action that a person or entity is bound or committed to perform within a time period or by a particular time or date, i.e., according to a time constraint. For example, a person may have an obligation to pay back a loan by the end of the month. As another example, a person may have an obligation to pay $50 per month to another person at the end of each calendar month for five years. As another example, a landscaping company may have an obligation to perform landscaping services at a facility three times per week for a year. As another example, the seller of a landscaping company may have an obligation to refrain from competing in the landscaping business for two years following the sale of the landscaping company.

As used herein, the phrase “annotation” refers to any information associated with an electronic contract. An annotation may be included within a single file that contains both the electronic contract and the annotation. Alternatively, the annotation may be logically or organizationally separate from the electronic contract. For example, an annotation may be stored in a database entry that includes the information and identifies the associated contract and/or contract subsection.

As used herein, the phrase “participant” refers to any person or entity who enters into an electronic contract, incurs an obligation in an electronic contract, or receives a benefit from performance of an obligation incurred in an electronic contract. A performing participant is a person or entity who incurs an obligation to perform under the contract. A benefited participant is a person or entity who benefits from performance of an obligation incurred in an electronic contract. Participants may be, but are not necessarily, parties to an electronic contract who have executed the electronic contract. For example, a car buyer may contract with a car seller and agree to pay the car seller's brother money in exchange for receiving a car from the car seller. In this example, each of the car buyer, the car seller, and the car seller's brother is a participant.

As used herein, the phrase “independent” refers to a server not being controlled or owned by a participant in an electronic contract. Rather the server is controlled by a third party who is not directly involved as a participant in the electronic contract transaction as a participant. For example, if two parties are the participants in an electronic contract, a server is independent if operated by a third party who is not a participant in the electronic contract and not owned or controlled by either of the two parties.

As used herein, the phrase “subsection” refers to a portion of an electronic contract that is less than all of the content of the electronic contract. For example, where the electronic contract comprises text clauses specifying the terms of the contract, a subsection is any one or more clauses that is less than all of the clauses. As another example, where the electronic contract comprises an audio recording of a discussion specifying the terms of the contract, a subsection is a portion of the recording that includes discussion of one or more, but less than all, of those terms.

Referring now to the drawings, FIG. 1 is a block diagram depicting an example of a system for monitoring and tracking obligations of electronic contracts using an independent monitoring server 102. Monitoring server 102 interacts with remote computing devices over network 115. Monitoring server 102 stores obligation information. In one embodiment, such obligation information is received from a remote source such as from electronic signature service 104. In this example, electronic signature service 104 is used to obtain signatures from contract participants to facilitate execution of an electronic contract. The electronic signature service 104 may be used to identify contract obligation information to be associated with an electronic contract and may store such information in one or more annotations that are associated with the electronic contact. In another example, monitoring server 102 receives electronic contracts and automatically and/or based on user input identifies obligation information from the electronic contracts and stores the obligation information as annotations to the electronic contracts.

In one embodiment, a single, independent third party entity operates both a monitoring server and the electronic signature server, which may be combined within a single device, to facilitate both the formation of electronic contracts and the subsequent monitoring of the created obligations for the electronic contracts.

The monitoring server 102 uses annotations to provide obligation information to participants 112a-c to an electronic agreement. For example, the monitoring server 102 may send reminders or other notifications to participants 112a-c through participant devices 110a-c. As a specific example, the monitoring server 102 may identify that a payment is due from a participant 112a under an electronic contract based on an annotation stored for the electronic contract on the monitoring server 102. The monitoring server may then send participant 112a an e-mail reminder 5 days before the payment is due reminding the participant 112a of the upcoming payment due date. The reminder may provide additional or alternative information about the obligation. In one example, the reminder includes a copy of the electronic agreement and identifies the relevant clause within the electronic agreement specifying the payment obligation terms.

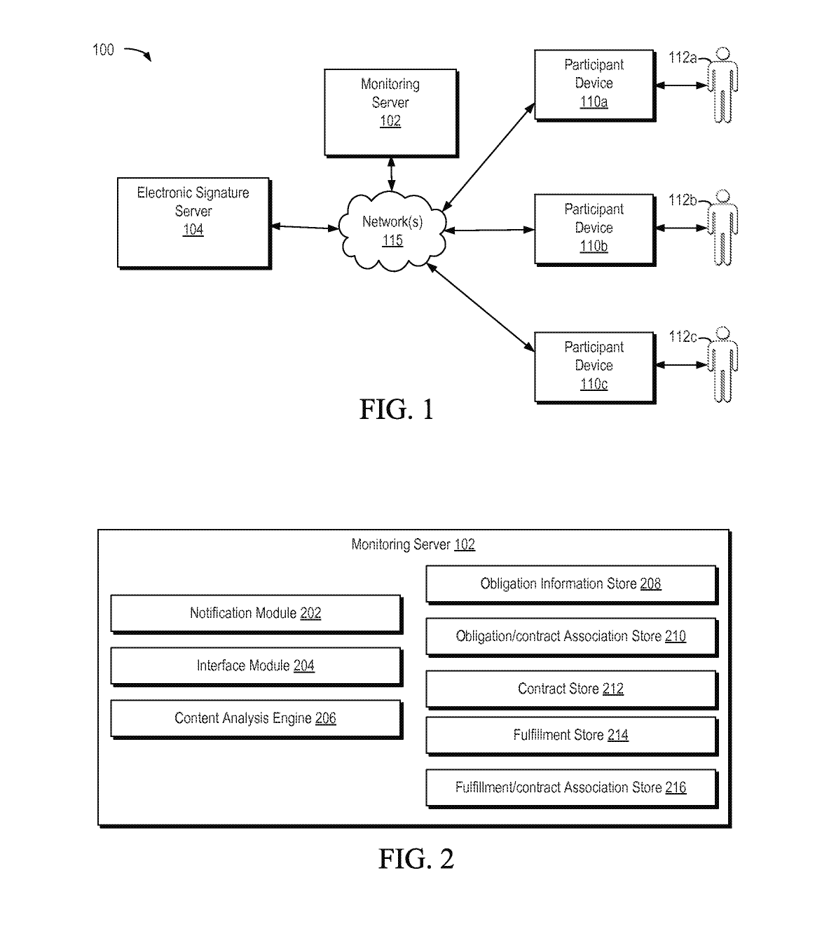

FIG. 2 is a block diagram illustrating exemplary modules for implementing functions in monitoring server 102 of FIG. 1. Server 102 includes modules 202, 204, and 206 which each are implemented by a processor executing stored computer instructions, and stores 208, 210, 212, 214, and 216 which store information on a non-transitory computer-readable medium. The notification module 202 sends e-mails, simple mail transfer protocol messages, fax messages, voice messages, audio recorded messages, video recorded messages, text messages, instant messages, application programming interface calls, remote procedure calls, or any other type of messages directed to a remote device for user or machine use. Such messages notify the recipient device and/or user of an obligation associated with an electronic contract. In one example, a buyer and a seller are each sent a reminder message of an upcoming payment being due. The notification module 202 identifies obligation information used to identify whether a notification is required and what obligation information to include such notifications using obligation information store 208. For example, the notification module 202 may use an annotation to an electronic contract to identify that a reminder should be sent 5 days prior to a scheduled service date to remind a service provider to provide service on the scheduled service date.

The notification module 202 uses obligation/contract association store 210 to identify which contract is associated with a given obligation and uses contract store 212 to retrieve the associated contract. The notification module can include information about the associated contract in the notification message that is sent. In one example, the notification message include the electronic contract so that the recipient can easily identify the basis for the obligation.

The notification module 202 uses information in fulfillment store 214 to provide notification messages to participants to electronic contracts. The fulfillment to the contract association store can associate fulfillment events with particular contracts and contract obligations. The notification module 202 sends messages to inform the participants that particular obligations have been fulfilled. Such messages may be triggered by fulfillment events, provided based on a schedule, or provided based on any other suitable criteria. The information about fulfillment of the obligations that is stored in the fulfillment store 214 and fulfillment to contract association store 216 can be provided from one or more of the participants. In one example, a benefited recipient informs the monitoring server 102 that a benefit has been received in fulfillment of a contract obligation and the monitoring server 102 updates the fulfillment store to indicate this event.

The interface module 204 similarly uses information in the stores 208, 210, 212, 214, 216 to provide obligation and fulfillment information to electronic contract participants. In one example, interface module 204 provides a website of one or more web pages that allows participants to log in and access obligation and fulfillment information. Such an interface may provide overview information, for example, allowing a participant to view obligations for multiple (potentially unrelated) obligations together. In one example, the interface shows a timeline or other time-based representation of upcoming (e.g., within a next week, month, year) obligations to be performed by the participant or to benefit the participant. The interface module 204 may provide access to the associated electronic contracts to allow the participants to easily see the basis for each obligation.

Content analysis engine 206 is used to identify obligations based on the content of an electronic contract. In the case of a text document specifying terms of the electronic contract, the content analysis engine 206 may analyze the text to identify obligations. In the case of an audio recording, the content analysis engine 206 may convert the speech to text and analyze the text to identify obligations. Similarly, in the case of a video recording, the content analysis engine 206 may convert the speech in the video to text and analyze the text to identify obligations. The obligations identified by the content analysis engine 206 may be confirmed manually. In one example, the content analysis engine identified obligations as part of a signature workflow so that a participant signing an electronic contract is asked to confirm information about obligations created by the electronic contract at or around the time of signing the electronic document to reduce the burden on the participant.

### Exemplary Obligation Tracking Techniques

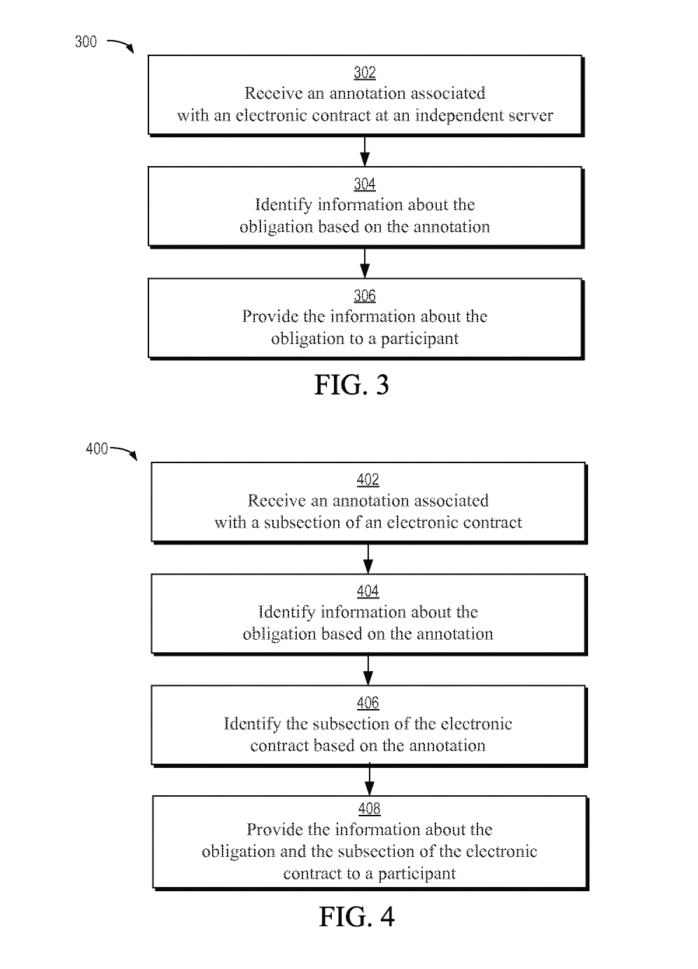

FIG. 3 is a flow chart of an exemplary method 300 for providing information about an obligation of an electronic contract. Method 300 can be performed by server 102 of FIG. 1 or any other suitable device. Method 300 involves receiving an annotation associated with an electronic contract at an independent server, as shown in block 302. In one embodiment, this involves receiving, at an electronic contract obligation server, an annotation that specifies the obligation to be performed by a performing participant of the electronic contract according to a time constraint for the benefit of a benefited participant of the electronic contract. The electronic contract obligation server can be, but need not be, independent of the performing participant and the benefited participant.

Method 300 further involves identifying information about the obligation based on the annotation, as shown in block 304. In one example, the annotation is stored as part of the electronic contract and identifying information about the obligation involves accessing the electronic document and identifying the metadata, markup language, or other part of the document storing the annotation.

Method 300 next involves providing the information about the obligation to a participant, as shown in block 306. In one embodiment, providing the information involves sending an electronic notification to either a contact associated with the performing participant or a contact associated with the benefited participant, or both. In another embodiment, providing the information involves sending periodically-recurring reminder messages. The annotation may specify a reminder schedule, for example, specifying timing for sending periodically-recurring reminder messages.

Providing information about the obligation may send information to a human contact or to a computer interface. For example, the server may send the information regarding upcoming obligations directly to a business' or other participant's financial or other automated computing systems. Alternatively, a participant's computing system may automatically query the server to receive the information about the obligation.

The server may provide the information about the obligation to a participant person (or contact of a business participant) through a user interface. The person may log in to the user interface and see listings about the obligation and other obligations managed by the server for the participant. Such a user interface can be used to provide information to both performing participant and benefited participants. Such an interface may also be used to access electronic contacts that are archived or otherwise stored by the server.

The information about the obligation may include the electronic contract itself. This is facilitated, in one example, by storing the electronic contract at an electronic contract obligation server and providing the electronic contract to the performing participant or the benefited participant as an attachment to a notification message.

FIG. 4 is a flow chart of another exemplary method 400 for providing information about an obligation of an electronic contract. Method 400 can be performed by server 102 of FIG. 1 or any other suitable device. Method 400 involves receiving an annotation associated with a subsection of an electronic contract, as shown in block 402. In one embodiment, the subsection is one or more particular clauses of the electronic contract that specify the details of the obligation. For example, if the obligation is to make a payment by a certain date, the details may specify the amount of the payment, the date the payment is due, the penalty for failing to make the payment by a specified time, to whom the payment is to be made, etc.

Method 400 further involves identifying information about the obligation based on the annotation, as shown in block 404. This can involve similar functions as discussed above with respect to block 304 of FIG. 3.

Method 400 further involves identifying the subsection of the electronic contract based on the annotation, as shown in block 406. In one example, the annotation is stored as part of the electronic contract and identifies the subsection by its location within the file. For example, the annotation may be within markup language statements associated with or identifying the subsection and defining the content (e.g., the text of the clauses) of the subsection. In this example, identifying information about the obligation involves accessing the electronic document and identifying based on the markup language statements the subsection to which the annotation is associated. In another example, a file format of the electronic document (e.g., portable document format “PDF”) uses annotations that are associated with particular portions of the document. In this example, identifying information about the obligation involves identifying the subsection based on the format of the electronic document. In yet another example, the annotation includes a location indication that indicates a location within the document that is associated with the annotation. For example, a location indication may indicate that the annotation is associated with page 4, lines 20-25 of the document.

Method 400 next involves providing the information about the obligation and the subsection of the electronic contract to a participant, as shown in block 406. The information is provided through a notification message or to a participant accessing a user interface in certain embodiments. The subsection can be identified by providing location information such as page and line numbers, by providing the electronic contract with the subsections highlighted or otherwise distinguished, or by providing the electronic contract subsection isolated from the remainder of the remainder of the electronic contract.

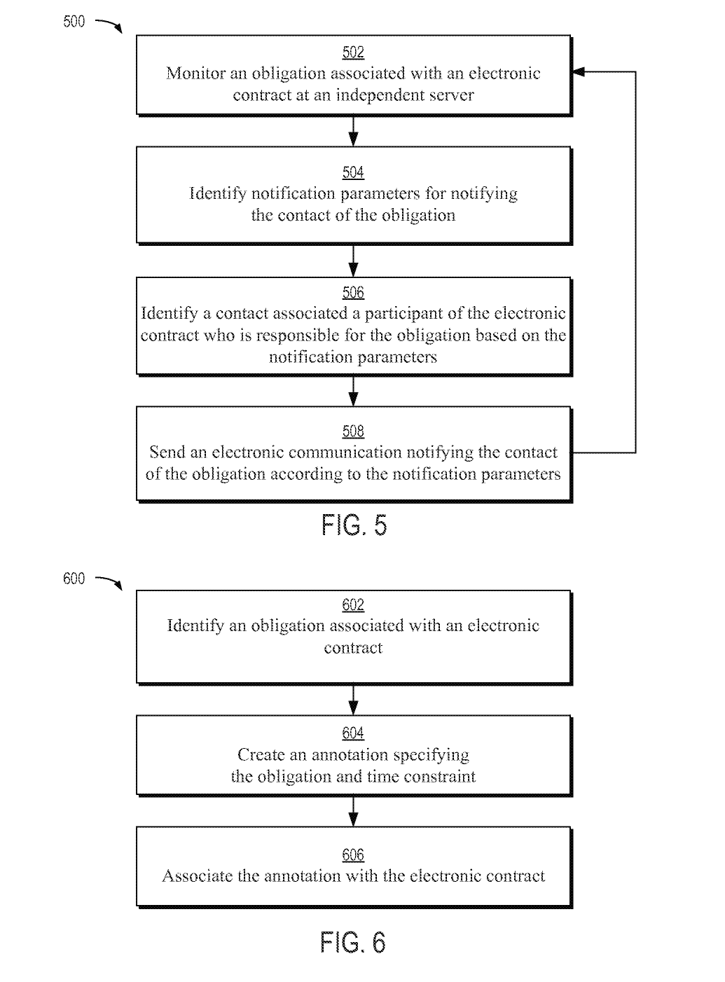

FIG. 5 is a flow chart of an exemplary method 500 of using notification parameters to notify a participant regarding an electronic contract obligation. Method 500 can be performed by server 102 of FIG. 1 or any other suitable device. Method 500 involves monitoring an obligation associated with an electronic contract at an independent server, as shown in block 502. This can involve the server storing one or more annotations that specify the obligation and other obligations associated with the electronic contract. The annotations can include time constraint information that is monitored by an automatic monitoring process.

The method 500 further involves identifying notification parameters for notifying a contact of the obligation, as shown in block 504. The notification parameters may have been manually specified by one or more of the participants. For example, a participant may have requested to be reminded of a payment obligation one week before the payment is due and the notification parameters may record this request.

Method 500 further involves identifying a contact associated with a participant of the electronic contract who is responsible for the obligation based on the notification parameters, as shown in block 506. The notification parameters specify (either implicitly or explicitly) who or what to contact with the notification. For example, the notification parameters may specify that a particular accounts receivable manager, John Doe, is to receive a notification at his e-mail address, john.doe@example.com. Alternatively, the notification parameters may specify a particular business role, e.g., division X accounts payable manager, and a separate lookup may be performed to identify the individual currently performing that role and the individual's contact information so that the notification can be sent to that person. In the case of a non-human recipient, such as a computing system, the notification parameters specify contact information that allows the message to be sent directly to the computing system or other non-human recipient.

Method 500 further involves sending an electronic communication notifying the contact of the obligation according to the notification parameters, as shown in block 508. The notification may be included in e-mails, simple mail transfer protocol messages, fax messages, voice messages, audio recorded messages, video recorded messages, text messages, instant messages, application programming interface calls, remote procedure calls, or any other type of messages directed to a remote device for contact or machine use. Such messages notify the recipient device and/or contact of an obligation associated with an electronic contract. After sending the notification, the method 500 returns to block 502 to continue monitoring obligations associated with the electronic contract.

An electronic contract obligation server can link directly to a participant's other systems. In one example, a participant uses a bill pay system and the electronic contract obligation server sends notification messages in a form that the bill pay system understands so it is not necessary for a human to be involved. Account receivable notification can similarly be sent directly to an accounts receivable system. Because notifications coming from a third trusted party, i.e., from an independent electronic contract obligation server, can be expected to be trustworthy, human review is reduced or eliminated. One embodiment involves a fully automated sender, signer experience in which, for example, sales persons create annotated contracts and assign obligations that are automatically saved as annotations and uploaded to the electronic contract obligation service. The electronic contract obligation service then automatically provides obligation notification messages to the appropriate systems within the business to facilitate tracking of the obligations, e.g., to ensure that obligations are correctly, completely, and timely performed.

The monitoring of obligations may further involve tracking post contract assignments of obligations through subsequent agreements and modifications, e.g., mortgage assignments. Such modifications can also be stored as annotations that, for example, reference both the new contract that makes the modification as well as the original contract with the original provision. In one embodiment, a notification identifying a modified obligation identifies both the modified obligation and the original obligation. The notification, in one example, further identifies the basis for both the original obligation and the modified obligation, e.g., by providing both electronic contracts or identifying the relevant provisions from each of the electronic contracts. This allows a participant to more easily understand the basis for obligations as the obligations change over time. Similarly, if a mortgage contract is assigned to a new lender by an assignment agreement, the obligation information can include the original agreement and the assignment agreement.

In addition to tracking obligations, fulfillment of obligations is also tracked in one embodiment. For example, this may involve tracking performance of the obligation by the performing participant and providing information about the performance of the obligation to the performing participant or the benefited participant. Notification parameters associated with an electronic contract in an annotation may specify that one or more participants are to be notified based on recognition that the obligation has been performed and thus fulfilled. The electronic contract obligation service may receive information about the fulfillment of obligations from the participants, trusted third parties, or any other source.

### Exemplary Annotation Techniques

FIG. 6 is a flow chart of an exemplary method 600 of creating an annotation associated with an electronic contract to specify an obligation of the electronic contract. Method 600 can be performed by either of servers 102, 104 of FIG. 1 or any other suitable device.

Method 600 involves identifying an obligation associated with an electronic contract, as shown in block 602. The obligation may be associated with a subsection of the electronic contract and that particular subsection may be identified. The subsection can be identified in various ways. In one example, the subsection is identified based on receiving user input identifying the subsection of the electronic contract as a source of the obligation. Another embodiment involves automatically identifying the subsection of the electronic contract as a source of the obligation using a natural language processing algorithm. User input may be requested and received to confirm that the automatically-identified subsection of the electronic contract is the source of the obligation.

Identifying the obligation can be facilitated by providing a user interface with particular features. In one example, the user interface can ask the participant to annotate the contract, for example, by using a mouse to highlight text within the electronic agreement (or along a timeline of an audio file) to identify the subsection that applies for a particular obligation. Alternatively, the user interface may provide customized tags to be inserted into a file. For example, where the contract is represented by an extensible markup language (XML) document or some other form of structured data, the user may be prompted to add an annotation tag or to select an appropriate location in the structure for an annotation tag. Additional user interface features appropriate for the particular system may additionally or alternatively be used.

Identifying the obligation, in one example, involves receiving input identifying an obligation parameter of the obligation, specifying how the obligation is to be performed. The obligation parameter, for example, may specify to whom payment should be made, method of delivery, amount, etc. Identifying the obligation, in another example, involves receiving input identifying a notification parameter specifying how one or more electronic contract participants is to receive notifications regarding the obligation. The notification parameter, for example, may specify that the participant desires to be reminded of the obligation by weekly e-mail messages sent the day the obligation is due at noon.

The method 600 further involves creating an annotation specifying the obligation and a time constraint for the obligation, as shown in block 604. An exemplary annotation specifies that payment is due on the 15^{th} of every other month. The annotation specifies the obligation parameters and notification parameters as applicable. The annotation may be stored as part of the electronic contract in a single electronic document or may be stored in a separate file, database, or other storage mechanism. The annotation specifies who will receive notification, for example, specifying that both the performing party and benefited party will receive notifications regarding the obligation.

The method 600 further involves associating the annotation with the electronic contract, as shown in block 606. The annotation is used to identify information about the obligation that is provided to the performing participant or the benefited participant.

Exemplary Electronic Contract Signature and obligation Tracking Techniques

In one example, an electronic contract obligation service is combined with an electronic signature service. In such a circumstance, the combined service will generally identify who the electronic contract participants are, contact information for appropriate contacts of the participants, the obligations of the electronic contract, and an event stream of when the contract is signed. All this information could be used in tracking the contract obligations. Such information can be obtained in whole or in part during the signature processes facilitated by an electronic signature service. In an alternative embodiment, a paper contract is scanned to create an electronic content and the relevant information is obtained through character recognition, text analysis, and/or user input.

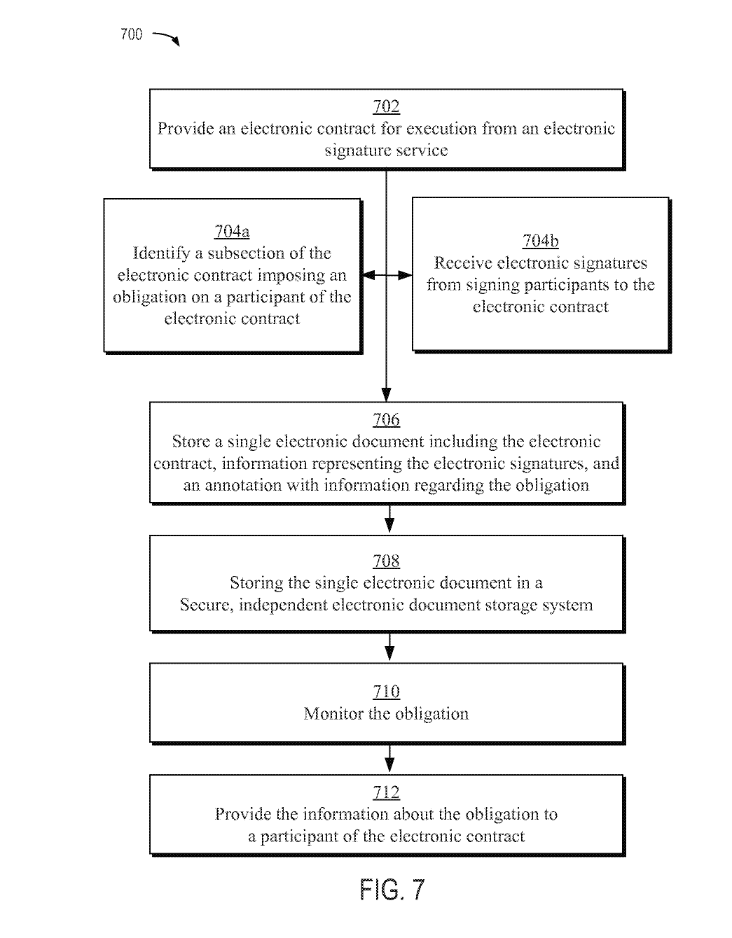

FIG. 7 is a flow chart of an exemplary method 700 for managing electronic signature and obligation tracking for electronic contracts. Method 700 can be performed by either of servers 102, 104 of FIG. 1 or any other suitable device. Method 700 involves providing an electronic contract for execution from an electronic signature service, as shown in block 702. The method 700 then, in any appropriate order, identifies a subsection of the electronic contract imposing an obligation on a participant of the electronic contract, as shown in block 704a, and receives electronic signatures from signing participants to the electronic contract, as shown in block 704b.

Method 700 further involves storing a single electronic document including the electronic contract, information representing the electronic signatures, and an annotation with information regarding the obligation, as shown in block 706. Method 700 further involves storing the single electronic document in a secure, independent electronic document storage system, as shown in block 708. Alternatively, the electronic document with the electronic signatures may be stored separately from the annotation.

The method 700 further monitors the obligation, as shown in block 710, and provides the information about the obligation to a participant of the electronic contract, as shown in block 712. As described with respect to prior examples, the notification can provide various types of information about the obligation and the electronic contract and can be provided in any suitable form, e.g., via a message, user interface, or otherwise.

### Exemplar Computing Environment

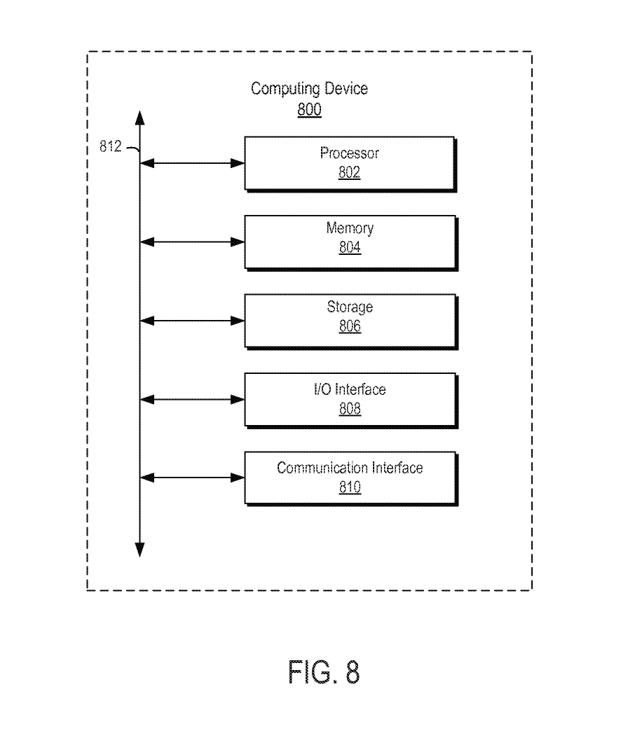

Any suitable computing system or group of computing systems can be used to implement the computer devices 102, 104, 106, 110a-c of FIG. 1 or otherwise used to implement the techniques and methods disclosed herein. For example, FIG. 8 is a block diagram depicting examples of implementations of such components. The computing device 800 can include a processor 802 that is communicatively coupled to a memory 804 and that executes computer-executable program code and/or accesses information stored in the memory 804 or storage 806. The processor 802 may comprise a microprocessor, an application-specific integrated circuit (“ASIC”), a state machine, or other processing device. The processor 802 can include one processing device or more than one processing device. Such a processor can include or may be in communication with a computer-readable medium storing instructions that, when executed by the processor 802, cause the processor to perform the operations described herein.

The memory 804 and storage 806 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Peri, JavaScript, and ActionScript.

The computing device 800 may also comprise a number of external or internal devices such as input or output devices. For example, the computing device is shown with an input/output (“I/O”) interface 808 that can receive input from input devices or provide output to output devices. A communication interface 810 may also be included in the computing device 800 and can include any device or group of devices suitable for establishing a wired or wireless data connection to one or more data networks. Non-limiting examples of the communication interface 810 include an Ethernet network adapter, a modem, and/or the like. The computing device 800 can transmit messages as electronic or optical signals via the communication interface 810. A bus 812 can also be included to communicatively couple one or more components of the computing device 800.

The computing device 800 can execute program code that configures the processor 802 to perform one or more of the operations described above. The program code can include one or more of the modules of FIG. 2. The program code may be resident in the memory 804, storage 806, or any suitable computer-readable medium and may be executed by the processor 802 or any other suitable processor. In some embodiments, modules can be resident in the memory 804. In additional or alternative embodiments, one or more modules can be resident in a memory that is accessible via a data network, such as a memory accessible to a cloud service.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure the claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. In a computer network environment, a method for providing information about an obligation of an electronic contract, the method comprising:
receiving, at an electronic contract obligation server, an annotation associated with the electronic contract, the annotation specifying the obligation to be performed by a performing participant of the electronic contract according to a time constraint for the benefit of a benefited participant of the electronic contract, the electronic contract obligation server independent of the performing participant and the benefited participant;
identifying, by the electronic contract obligation service, the information about the obligation based on the annotation associated with the electronic contract; and
providing, by the electronic contract obligation service, the information about the obligation to the performing participant or the benefited participant.

2. The method of claim 1 wherein providing the information comprises sending an electronic notification to a contact associated with the performing participant or the benefited participant.

3. The method of claim 1 wherein providing the information comprises providing a subsection of the contract specifying the obligation associated with the annotation.

4. The method of claim 1 wherein providing the information comprises sending periodically-recurring reminder messages, wherein the annotation specifies a reminder schedule for sending the periodically-recurring reminder messages.

5. The method of claim 1 wherein providing the information comprises sending an electronic communication to an automated system of the performing participant or the benefited participant.

6. The method of claim 1 wherein providing the information comprises making the contract obligation available through a user interface, wherein a contact associated with the performing participant or the benefited participant accesses the user interface electronically to access the information.

7. The method of claim 1 further comprising:
tracking performance of the obligation by the performing participant; and
providing information about the performance of the obligation to the performing participant or the benefited participant.

8. The method of claim 1, wherein the annotation is stored as part of the electronic contract in a single electronic document.

9. The method of claim 1 further comprising storing the electronic contract at the electronic contract obligation server and providing the electronic contract to the performing participant or the benefited participant.

10. The method of claim 1 further comprising updating the annotation based on a change resulting from a modification to the electronic agreement or a subsequent agreement.

11. In a computer network environment, a method of annotating an electronic contract to provide information about an obligation of the electronic contract, the method comprising a processor performing operations comprising:
identifying the obligation associated with a subsection of the electronic contract, the obligation to be performed by a performing participant of the electronic contract according to a time constraint for the benefit of a benefited participant of the electronic contract;
creating an annotation specifying the obligation and the time constraint; and
associating the annotation with the electronic contract, wherein the annotation is used to identify information about the obligation that is provided to the performing participant or the benefited participant.

12. The method of claim 11 further comprising receiving input identifying a subsection of the electronic contract as a source of the obligation, wherein the annotation identifies the subsection of the electronic contract as the source of the obligation.

13. The method of claim 11 further comprising automatically identifying a subsection of the electronic contract as a source of the obligation using a natural language processing algorithm, wherein the annotation identifies the subsection of the electronic contract as the source of the obligation.

14. The method of claim 11 further comprising:
automatically identifying a subsection of the electronic contract as a source of the obligation using a natural language processing algorithm, wherein the annotation identifies the subsection of the electronic contract as the source of the obligation; and
receiving user input confirming that the subsection of the electronic contract is the source of the obligation.

15. The method of claim 11 further comprising:
receiving input identifying an obligation parameter of the obligation, specifying how the obligation is to be performed; and
including the obligation parameter in the annotation.

16. The method of claim 11 further comprising:
receiving input identifying a notification parameter specifying how one or more electronic contract participants is to receive notifications regarding the obligation; and
including the notification parameter in the annotation.

17. The method of claim 11 further comprising storing the annotation as part of the electronic contract in a single electronic document.

18. The method of claim 11 further comprising:
providing an electronic signature interface for the performing party or benefited party to both execute the electronic contract and identify or confirm the annotation.

19. The method of claim 11 wherein the annotation specifies that both the performing party and benefited party will receive notifications regarding the obligation.

20. A system comprising:
a processing device; and
a memory device communicatively coupled to the processing device,
wherein the processing device is configured to execute instructions included in the memory device to perform operations comprising:
receiving, at an electronic contract obligation server, an annotation associated with the electronic contract, the annotation specifying the obligation to be performed by a performing participant of the electronic contract according to a time constraint for the benefit of a benefited participant of the electronic contract, the electronic contract obligation server independent of the performing participant and the benefited participant;
identifying, by the electronic contract obligation service, the information about the obligation based on the annotation associated with the electronic contract; and
providing, by the electronic contract obligation service, the information about the obligation to the performing participant or the benefited participant.
